(19) United States
(12) Patent Application Publication
(10) Pub. No.: US 2005/0145623 A1
(43) Pub. Date: Jul. 7, 2005

(54) Cooking tray for rapid cook oven

(76) Inventors: James K. Pool III, Richardson, TX (US); Peter Ashcraft, McKinney, TX (US)

Correspondence Address: JOHN S. PRATT, ESQ;KILPATRICK STOCKTON, LLP, 1100 PEACHTREE STREET, ATLANTA, GA, 30309, US

(21) Appl. No.: 10/746,409

(22) Filed: Dec. 24, 2003

(51) Int. Cl. H05B 6/80

(52) U.S. Cl. 219/730

(57) ABSTRACT

A cooking tray (optionally interstices-defining, microwave-transparent and providing an appropriate view factor) has a one-piece, integral, unitary construction formed of a food-grade, non-stick material suitable for use in a rapid cook oven which cooks by a combination of at least two heat transfer mechanisms selected from the group consisting of radiant heat transfer, convection heat transfer and microwave energy transfer. The construction defines a base and an upstanding peripheral sidewall about the base for the collection of solid debris created during cooking. Preferably the material is food-grade fiberglass with a non-stick coating.

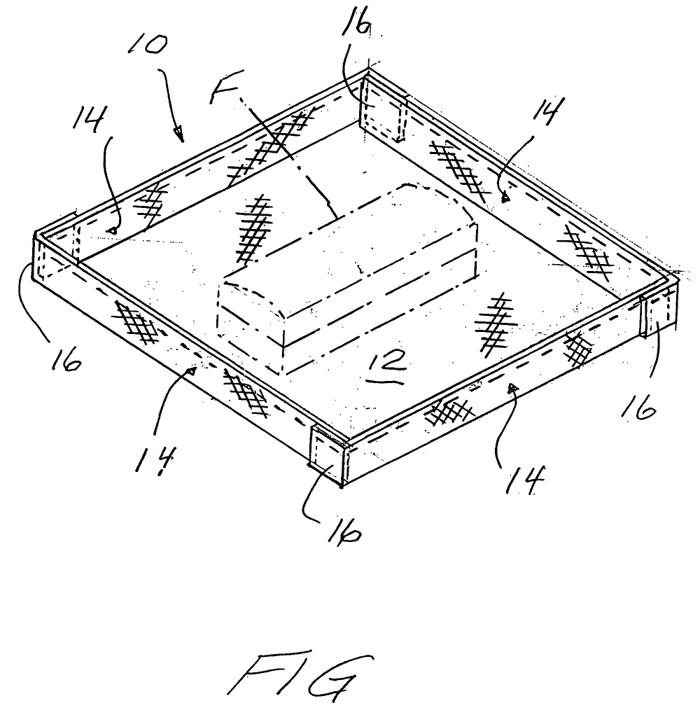

### BACKGROUND OF THE INVENTION

The present invention relates to a cooking tray for the support of foodstuffs in an oven and the transportation thereof to and from the oven, and more particularly to such a tray which is suitable for use in a rapid cook oven.

In a commercial environment such as a busy restaurant, moving foodstuffs directly into or out of hot oven without the use of a cooking tray may be difficult, messy, time-consuming and hazardous.

As cooking ovens have become more complex and sophisticated, it has become correspondingly more difficult to provide a cooking tray suitable for use therewith. The cooking tray must not only support the foodstuffs within the cooking chamber of the oven, but also be suitable for the transport of the foodstuffs to and from the oven. In the past, cooking trays were simple metallic or ceramic-like vessels such as a metallic sheet pan, a ceramic bowl, a pot or the like.

In a rapid cook oven, however, the type of cooking tray can greatly impact the performance of the rapid cook oven, frequently requiring significantly longer cook times. For example, in a microwave oven a metallic sheet pan will block microwave energy from entering the foodstuff from the side in contact with the metallic pan. Further, in a convection oven, the use of a metallic or ceramic cooking tray may strongly impact the degree of browning obtainable due to the time it takes to heat the tray to a browning temperature. In conventional (non-rapid cook) ovens this was not a problem since the total cook times were significantly longer, and the time required for heating of the cooking tray was a negligible fraction of the total cook time. However, in rapid cook ovens where the total cook time may be only 35 to 120 seconds, the time required to heat the cooking tray may represent a significant fraction of the total cook time, thereby requiring a longer total cook time.

For the purposes of this specification and the appended claims, a rapid cook oven is defined as any oven that uses multiple heat transfer mechanisms (that is, at least two heat transfer mechanisms) acting simultaneously or near simultaneously in order to reduce the conventional cook times by at least 50%. Typical heat transfer mechanisms include convection heat transfer (including hot air impingement airflow), radiant heat transfer (where the radiant heat comes from a radiating heat source), and microwave energy transfer (which some consider a special form of radiant heat transfer).

As already noted, in a convection oven the cooking tray should readily conduct heat. Therefore the tray should be made from a material exhibiting a very high thermal conductivity and/or have such a low mass that the tray will rapidly achieve the temperature required for optimal browning of the foodstuff thereon. Where the rapid cook oven employs hot-air impingement-type convection heating through the cooking tray, it is necessary for the tray to permit the flow of hot air therethrough—for example, through perforations, interstices or apertures in the base of the tray. In a radiant heat oven the tray should pass the radiant heat from the radiant heat source through the tray to the foodstuff without obstruction—for example, that there be an appropriate view factor between the foodstuff and the radiant heat source. In a microwave oven the tray should be essentially metal-free so that the microwave energy can pass therethrough to the foodstuff and the tuning of the magnetrons is not disturbed by the presence of metal in the cooking chamber. Thus each of the heat transfer mechanisms used by a particular rapid cook oven imposes requirements on the cooking tray and limits those trays which are suitable for use in that particular oven.

For example, a cooking tray suitable for use in rapid cook oven which utilized each of the three heat transfer mechanisms would require a tray that had low mass, high thermal conductivity, was metal free, permitted hot air flow therethrough, and provided an appropriate view factor for radiation heating.

While the perforations, apertures or interstices of the cooking tray must be sufficiently large to allow hot air flow therethrough, they must also be sufficiently small to provide for the collection thereon of solid debris created during the cooking operation. Removal of the solid debris with the cooking tray is highly preferable to allowing the debris to remain in the cooking chamber, as it is usually more difficult to periodically remove the repeatedly cooked-on debris from the cooking chamber. The perforations, apertures or interstices of the cooking tray may or may not be sufficiently large to allow the collection of liquid debris (e.g., juices from the foodstuff) to collect thereon for easy removal from the cooking chamber, depending on the type of cooking being performed.

Of course, a cooking tray must be made of food—grade material—that is, material which can come into contact with foodstuffs without harmful effect on the foodstuffs. To facilitate cleaning of the tray and the removal of the cooked foodstuffs from the tray, the tray is preferably formed of non-stick material. To reduce the manufacturing cost of the cooking tray, it is preferably of one-piece, integral and unitary construction.

Accordingly, it is an object of the present invention to provide a cooking tray which is suitable for us in a rapid cook oven which cooks by a combination of at least two heat transfer mechanisms selected from the group consisting of radiant heat transfer, convection heat transfer, and microwave energy transfer.

Another object is to provide such a cooking tray which, in one preferred embodiment, is suitable for use in a rapid cook oven which cooks by all three heat transfer mechanisms.

A further object is to provide such a cooking tray which, in one preferred embodiment, is of one-piece, integral and unitary construction, and made of food-grade, non-stick material.

It is also an object of the present invention to provide such a cooking tray which, in one preferred embodiment, is inexpensive to manufacture and easy to use and maintain.

### SUMMARY OF THE INVENTION

It has now been found that the above and related objects of the present invention are obtained in a cooking tray comprising a one-piece, integral, unitary construction formed of a food-grade, non-stick material suitable for use in a rapid cook oven which cooks by a combination of at least two heat transfer mechanisms selected from the group consisting of radiant heat transfer, convection heat transfer and microwave energy transfer. The construction defines a base and an upstanding peripheral sidewall about the base for the collection of solid debris created during cooking.

The material may be is woven or nonwoven. Preferably the material is fiberglass with a non-stick coating.

In one preferred embodiment, the at least two heat transfer mechanisms includes microwave energy transfer, and the material is substantially microwave-transparent. In another, the at least two heat transfer mechanisms are microwave energy transfer and convection heat transfer, and the material is substantially microwave-transparent and defines interstices enabling the flow of hot air therethrough. In yet another, the at least two heat transfer mechanisms are microwave energy transfer and radiant heat transfer, and the material is substantially microwave-transparent and provides an appropriate view factor. In still another, the at least two heat transfer mechanisms are radiant heat transfer and convection heat transfer, and the material provides an appropriate view factor and defines interstices enabling the flow of hot air therethrough. Optimally the tray is suitable for use in a rapid cook oven cooking by any or all of said heat transfer mechanism and the material is substantially microwave-transparent, defines interstices and provides an appropriate view factor.

Preferably the material is 0.02 to 1.0 mm thick, and the interstices defined by said material have a major dimension of 1.5 to 3.0 mm and a minor dimension of 1.5 to 3.0 mm.

### BRIEF DESCRIPTION OF THE DRAWING

The above and related objects, features and advantages of the present invention will be more fully understood by reference to the following detailed description of the presently preferred, albeit illustrative, embodiments of the present invention when taken in conjunction with the accompanying drawing wherein:

The FIGURE is an isometric view of a cooking tray according to the present invention, with a foodstuff thereon indicated in phantom line.

### DETAILED DESCRIPTION OF THE PREFERRED EMBODIMENTS

Referring now to the drawing, and in particular to the FIGURE thereof, therein illustrated is a cooking tray according to the present invention, generally designated by the reference numeral 10. The tray 10 defines a base, generally designated 12, and an upstanding peripheral sidewall, generally designated 14, extending completely about the base 12. The base 12 and sidewall 14 cooperatively define an open-top container for the collection of solid debris created during cooking.

The tray 10 may be formed of a woven material defining interstices or a nonwoven material. Where the material is a nonwoven material for use in a convection oven, it is preferably perforated or apertured to define interstices, at least in the base 12 thereof, to allow hot air flow therethrough. The term “interstices” as used herein includes small apertures and perforations sufficient to allow airflow therethrough, but not solid food particles. A preferred construction is of fiberglass material having a food-grade, non-stick coating thereon (such as a TEFLON coating).

The tray 10 is formed of a material suitable for use in a rapid cook oven which cooks by a combination of at least two heat transfer mechanisms selected from the group consisting of radiant heat transfer, convection heat transfer and microwave energy transfer.

Where the at least two heat transfer mechanisms include microwave energy transfer, the material is substantially microwave-transparent—e.g., substantially metal-free. Where the at least two heat transfer mechanisms are microwave energy transfer and convention heat transfer, the material is both substantially microwave-transparent and defines interstices enabling the flow of hot air therethrough. Where the at least two heat transfer mechanisms are microwave energy transfer and radiant heat transfer, the material is substantially microwave-transparent and provides an appropriate view factor for radiant heat transfer. Where the at least two heat transfer mechanisms are radiant heat transfer and convection heat transfer, the material provides both an appropriate view factor and interstices enabling the flow of hot air therethrough. Selection of an appropriate view factor will, of course, take into consideration the interstices.

As used herein, the term “microwave transparent” refers to a microwave transparent property, a lossy (i.e., microwave absorptive) property or both, as each property advantageously utilizes microwave energy.

Optimally, the cooking tray 10 is suitable for use in a rapid cook oven cooking by any or all of the three heat transfer mechanisms identified above, and the material is substantially microwave-transparent, defines interstices and provides an appropriate view factor.

The cooking tray 10 is preferably manufactured from a single flat sheet of material of appropriate size. The marginal portions of the sheet about the base 12 are turned upwardly to form a sidewall 14 (preferably with a sidewall depth about the base 12 of approximately 25 mm). The adjacent edges of the sidewall portions are secured together by conventional corner-forming means (e.g., heat sealing, stitching, adhesives, or the like) to provide a continuous peripheral lip which will retain within the tray 10 any solid debris created during cooking of foodstsuffs. Additionally, the upturned sidewall 14 and corners 16 provide a very limited degree of rigidity to the base 12, and hence a certain degree of rigidity to the tray 10. However, it will be appreciated that, for the most part, any tray 10 of substantial size (that is, in length and width) will be substantially flexible and essentially non-self-supporting—i.e., it will require external support of the base 12 when the tray is being used to transport foodstuff of substantial weight (such as chicken, steak or sandwiches) into or from the cooking chamber of the rapid cook oven.

Typically the material is 0.02 to 1.0 mm thick. The interstices of the material preferably have a major dimension of 1.5 to 3.0 mm and a minor dimension of 1.5 to 3.0 mm. The cooking tray may be made available in a variety of different sizes and shapes to accommodate a variety of different-size rapid cook ovens, cook chambers and a variety of different-size foodstuffs.

To summarize, the present invention provides a cooking tray which is suitable for use in a rapid cook oven which cooks by a combination of at least two heat transfer mechanisms selected from the group consisting of radiant heat transfer, convection heat transfer and microwave energy transfer, the tray being suitable for use in a rapid cook oven which cooks by all three heat transfer mechanisms. The tray is of one piece, integral, unitary construction, made of a food-grade, non-stick material. The tray is inexpensive to manufacture and easy to use and maintain.

Now that the preferred embodiments of the present invention have been shown and described in detail, various modifications and improvements thereon will become really apparent to those skilled in the art. Accordingly, the scope of the present invention is to be construed broadly and limited only by the appended claims, and not by the foregoing specification.

1. A cooking tray comprising a one-piece, integral, unitary construction formed of a food-grade, non-stick material suitable for use in a rapid cook oven which cooks by a combination of at least two heat transfer mechanisms selected from the group consisting of radiant heat transfer, convection heat transfer and microwave energy transfer;
said construction defining a base and an upstanding peripheral sidewall about said base for the collection of solid debris created during cooking.

2. The tray of claim 1 wherein said material is a woven.

3. The tray of claim 1 wherein said material is a nonwoven.

4. The tray of claim 1 wherein said material is fiberglass with a non-stick coating.

5. The tray of claim 1 wherein said at least two heat transfer mechanisms include microwave energy transfer, and said material is substantially microwave-transparent.

6. The tray of claim I wherein said at least two heat transfer mechanisms are microwave energy transfer and convection heat transfer, and said material is substantially microwave-transparent and defines interstices enabling the flow of hot air therethrough.

7. The tray of claim 1 wherein said at least two heat transfer mechanisms are microwave energy transfer and radiant heat transfer, and said material is substantially microwave-transparent and provides an appropriate view factor.

8. The tray of claim 1 wherein said at least two heat transfer mechanisms are radiant heat transfer and convection heat transfer, and said material provides an appropriate view factor and defines interstices enabling the flow of hot air therethrough.

9. The tray of claim 1 suitable for use in an oven cooking by any or all of said heat transfer mechanisms, said material being substantially microwave-transparent, defining interstices, and providing an appropriate view factor.

10. The tray of claim 1 wherein said material defines interstices having a major dimension of 1.5 to 3.0 mm and a minor dimension of 1.5 to 3.0 mm.

11. The tray of claim 1 wherein said material is 0.02 to 1.0 mm thick.

12. The tray of claim 1 wherein said material is flexible, and the tray is essentially not self-supporting when carrying a foodstuff.
